(19) United States
(12) Patent Application Publication
(10) Pub. No.: US 2018/0080393 A1
(43) Pub. Date: Mar. 22, 2018

(54) CONTROL DEVICE APPLIED TO HYBRID VEHICLE

(71) Applicant: TOYOTA JIDOSHA KABUSHIKI KAISHA, Toyota-shi (JP)

(72) Inventors: Hidekazu NAWATA, Gotemba-shi (JP); Makoto YAMAZAKI, Gotemba-shi (JP); Tomoaki HONDA, Gotemba-shi (JP); Toshio INOUE, Gotemba-shi (JP)

(73) Assignee: TOYOTA JIDOSHA KABUSHIKI KAISHA, Toyota-shi (JP)

(21) Appl. No.: 15/647,778

(22) Filed: Jul. 12, 2017

(30) Foreign Application Priority Data
Sep. 20, 2016 (JP) 2016-183136

(51) Int. Cl. F02D 19/08; F02D 41/06; F02M 37/00

(52) U.S. Cl. CPC F02D 19/087; F02D 19/081; B60K 15/013; F02M 37/0082; F02D 41/064

(57) ABSTRACT

A control device of the present invention is applied to a hybrid vehicle having an internal combustion engine which is enabled to operate with fuels different in alcohol density from each other. In a case that fueling which causes change of alcohol density of fuel is implemented to the hybrid vehicle, the control device prohibits an intermittent stop of the internal combustion engine until fuel having an alcohol density changed by the fueling is supplied to the internal combustion engine.

### TECHNICAL FIELD

The present invention relates to a control device that is applied to a hybrid vehicle comprising both an internal combustion engine and an electric motor as power sources for propulsion.

### BACKGROUND ART

There is known an internal combustion engine which is enabled to operate by using fuel containing alcohol such as ethanol and methanol. As a control device for a hybrid vehicle comprising such an internal combustion engine, there is known a control device which executes fuel replacement control where in a case that a change from low volatile fuel to high volatile fuel is determined based on an alcohol density difference before and after fueling, fuel movement is prompted by increasing a flow rate of fuel returned to a fuel tank so that the low volatile fuel remaining in a fuel supply passage is replaced promptly with the high volatile fuel (refer to Patent Document #1).

### CITATION LIST

### Patent literature

Patent Document #1: Japanese Patent Publication 2011-231674 A.

### SUMMARY OF INVENTION

### Technical Problem

With respect to an internal combustion engine which is enabled to operate by using alcohol-containing fuel, since volatility of fuel changes depending on alcohol density and the change impinges on its start-up performance, it is general to change a start condition, for example, fuel injection amount for a start-up moment is increased according to the alcohol density. Due to this,in a case that the fueling which causes change of alcohol density of fuel is implemented to a hybrid vehicle disclosed in the patent literature #1, if the internal combustion engine is stopped for an intermittent stop at a moment immediately before completion of the replacement of fuel, at the subsequent restart-up moment, the start-up condition is not yet changed based on the alcohol density after the replacement, and thereby, a start-up performance of the internal combustion engine deteriorates.

Accordingly, the present invention aims to provide a control device for a hybrid vehicle that is capable of suppressing deterioration of a start-up performance of an internal combustion engine.

### Solution to Technical Problem

One aspect of the present invention provides a control device being applied to a hybrid vehicle in which an internal combustion engine and an electric motor are provided as power sources for propulsion, the internal combustion engine being enabled to operate with fuels different in alcohol density from each other, and start-up condition of the internal combustion engine changes according to alcohol density of fuel, wherein the control device is configured as a computer unit and is programmed to make the internal combustion engine stop for an intermittent stop to make the electric motor propel the hybrid vehicle, wherein the control device is further programmed to, in a case that fueling which causes change of alcohol density of fuel is implemented to the hybrid vehicle, prohibit the intermittent stop of the internal combustion engine until fuel having an alcohol density changed by the fueling is supplied to the internal combustion engine.

According to the control device of this aspect, in a case that fueling causing change of alcohol density of fuel is implemented, the intermittent stop is prohibited until fuel having an alcohol density changed by the fueling (hereinafter referred to as “the post-fueling fuel”) is supplied to the internal combustion engine. Due to this, it is avoidable that the intermittent stop is implemented at the moment immediately before the post-fueling fuel is supplied to the internal combustion engine. Thereby, it is possible to prevent the start-up performance of the internal combustion engine from deteriorating. In this control device, the intermittent stop may be continued to be prohibited even after the post-fueling fuel is supplied to the internal combustion engine.

In one embodiment of the control device as one aspect of the present invention, the control device may be further programmed to prohibit the intermittent stop of the internal combustion engine in a case that an alcohol-density change amount between before and after the fueling exceeds a determination value. According to this embodiment, it is possible to prohibit the intermittent stop depending on a degree of change in the alcohol density. For example, if the determination value is set in consideration of an influence on the start-up performance of the internal combustion engine, thereby, it is possible to exclude a fact that the intermittent stop is prohibited in a case that the alcohol density changes by a degree such that the change puts no influence on the start-up performance of the internal combustion engine. Thereby, it is possible to reduce an adverse effect such as fuel deterioration caused by the prohibition of the intermittent stop.

In this embodiment, the determination value may be set to a value differently depending on whether a case that the alcohol density rises for a period between before and after the fueling or a case that the alcohol density lowers for the period. Even if the alcohol-density change amounts for a period between before and after the fueling are equal to each other, there is a difference in a degree of influence on the start-up performance of the internal combustion engine between a case that the alcohol density rises for the period and a case that the alcohol density lowers for the period. Due to this, by setting the determination values suitable to the case that the alcohol density rises for the period and the case that the alcohol density lowers for the period respectively, it is possible to prohibit the intermittent stop of the internal combustion engine more appropriately.

Further, even if the alcohol-density change amounts between before and after the fueling are equal to each other, the degree of influence on the start-up performance of the internal combustion engine is different depending on the alcohol density obtained before the fueling. Accordingly, the determination value may be set according to the alcohol density obtained before the fueling.

In one embodiment of the control device as one aspect of the present invention, the hybrid vehicle may be provided with: a fuel tank; a fuel pathway running from the fuel tank to the internal combustion engine, and an alcohol density sensor provided on the fuel pathway and outputting a signal according to the alcohol density, and the control device may be further programmed to prohibit the intermittent stop of the internal combustion engine until an accumulated value exceeds a predetermined range corresponding to a volume of a part of the pathway from the alcohol density sensor to the internal combustion engine, the accumulated value being obtained by accumulating a fuel injection amount of the internal combustion engine after the fueling.

The moment when the post-fueling fuel is supplied to the internal combustion engine is coincident with the moment when fuel having a volume has been injected, the volume corresponding to a part of the fuel pathway from the alcohol density sensor to the internal combustion engine. That is, at the moment when the accumulated value of the fuel injection amount which is accumulated after the fueling reaches the mentioned volume, it is possible to make estimation that the post-fueling fuel has been supplied to the internal combustion engine and thereby the replacement of fuel has been completed. According to this embodiment, the intermittent stop of the internal combustion engine is prohibited until the accumulated value of the fuel injection amount of the internal combustion engine which is accumulated after the fueling exceeds a predetermined range corresponding to the volume of the part of the fuel pathway from the alcohol density sensor to the internal combustion engine. Due to this, since the prohibition period of the intermittent stop is terminated in time with the moment when the post-fueling fuel is supplied to the internal combustion engine, it is possible to suppress an excessively long prohibition period of the intermittent stop.

### BRIEF DESCRIPTION OF DRAWINGS

FIG. 1 is a diagram schematically showing a hybrid vehicle to which a control device according to one embodiment of the present invention is applied; and

FIG. 2 is a flow chart showing one example of a control routine.

### DESCRIPTION OF EMBODIMENTS

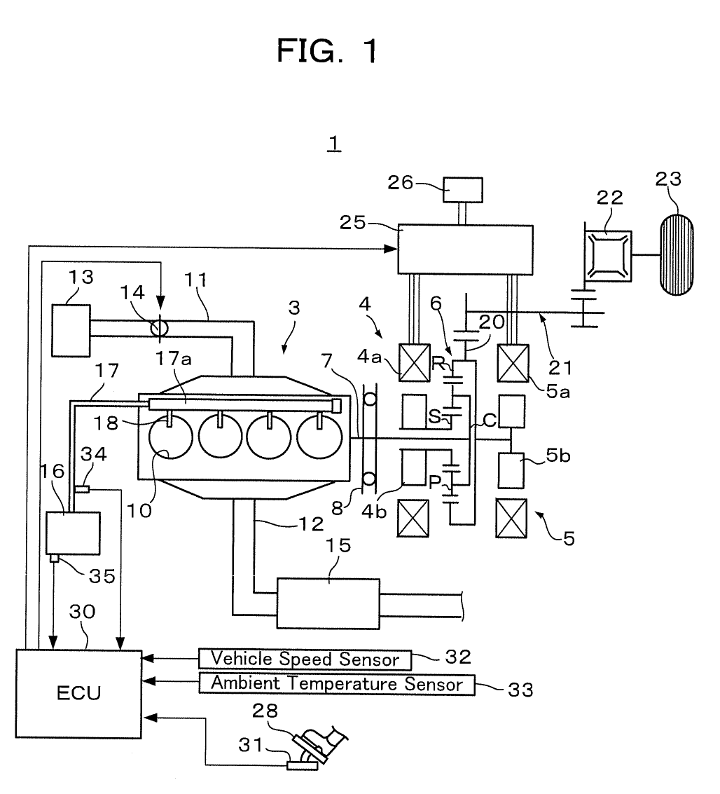

As shown in FIG. 1, a vehicle 1 is built as a series-parallel hybrid vehicle where at least two power sources are combined. The vehicle 1 comprises an internal combustion engine 3, and a first motor generator 4, and a second motor generator 5. The internal combustion engine 3 is an inline-four-cylinder internal combustion engine having four cylinders 10. The internal combustion engine 3 is enabled to operate by using alcohol-containing fuel. In general, a vehicle having an internal combustion engine which is enabled to operate by using alcohol-containing fuel is called a flexible fuel vehicle (FFV).

An intake passage 11 and an exhaust passage 12 are connected to each of the cylinders 10 of the internal combustion engine 3. The intake passage 11 is provided with an air cleaner 13 for air filtration and a throttle valve 14 enabled to adjust an airflow rate. The exhaust passage 12 is provided with a ternary catalyst which purifies harmful components included in exhaust gas. For supplying fuel to the internal combustion engine 3, the vehicle 1 is provided with a fuel tank 16 and a fuel pathway 17 running from the fuel tank 16 to the internal combustion engine 3. The fuel pathway 17 includes a delivery pipe 17a for delivering the fuel for each cylinder 10 of the internal combustion engine 3. A fuel injection valve 18 provided for each cylinder 10 is connected to the delivery pipe 17a.

The internal combustion engine 3 and the first motor generator 4 are connected to a power splitting mechanism 6. The output of the power splitting mechanism 6 is transmitted to an output gear 20. The output gear 20 and the second motor generator 5 are connected to each other in a power transmittable manner. The power outputted from the output gear 20 is transmitted to drive wheels 23 via a speed reducer 21 and a differential device 22. The first motor generator 4 has a stator 4a and a rotor 4b. The first motor generator 4 functions as an electric motor which is driven by alternating-current power, while functioning as an electric generator which generates electricity by receiving the power from the internal combustion engine 3, the power being split one by the power splitting mechanism 6. As with the first motor generator 4, the second motor generator 5 has a stator 5a and a rotor 5b, and functions as an electric motor and an electric generator respectively. Each of the motor generators 4 and 5 is electrically connected to a battery 26 via a control circuit 25 including an inverter not illustrated and the like. The control circuit 25 converts electric power generated by each of the motor generators 4 and 5 into direct current to charge the battery 26 and also converts electric power of the battery 26 into alternating current to supply the converted electric power to each of the motor generators 4 and 5. The battery 26 is configured so as to be charged by an external electric power source. That is, the vehicle 1 is built as a plug-in hybrid vehicle.

The power splitting mechanism 6 is built as a single-pinion planetary gear mechanism. The power splitting mechanism 6 has a sun gear S, a ring gear R, and a planetary carrier C holding, in a rotatable and revolvable manner, a pinion P engaging with the sun gear S and the ring gear R. The sun gear S is connected to the rotor 4a of the first motor generator 4, the ring gear R is connected to the output gear 20, and the planetary carrier C is connected to a clank shaft 7 of the internal combustion engine 3. There is a dumper 8 intervening between the crankshaft 7 and the planetary carrier C. The dumper 8 absorbs torque fluctuations of the internal combustion engine 3.

Controls in the vehicle 1 are executed by an electronic control unit (ECU) 30 built as a computer. The ECU 30 executes various controls for the internal combustion engine 3 and the motor generators 4 and 5 individually. Due to this, signals from various sensors, each detecting information of each portion of the vehicle 1, are inputted to the ECU 30. In the example shown, the vehicle 1 is provided with: an accelerator position sensor 31 which outputs a signal according to an amount that an accelerator pedal 28 has been pressed; a vehicle speed sensor 32 which outputs a signal according to a speed of the vehicle 1; an ambient temperature sensor 33 which outputs a signal according to an ambient temperature; an alcohol density sensor 34 which is provided to the fuel pathway 17 and outputs a signal according to an alcohol density of the fuel; and a fuel level sensor 35 which is provided to the fuel tank 16 and outputs a signal according to a remaining amount of the fuel. These output signals are inputted to the ECU 30.

The ECU 30 refers to the signals from the accelerator position sensor 31 and the vehicle speed sensor 32 to calculate a required power the driver is requiring, and controls the vehicle 1 while changing various modes so as to make system efficiency with respect to the required power optimum. For example, in a case that a driving condition changes while the vehicle 1 is traveling, the ECU 30 changes over from a hybrid mode where the internal combustion engine 3 and the second motor generator 6 are used as power sources to an EV mode by stopping combustion of the internal combustion engine 3, or from the EV mode to the hybrid mode by starting up the internal combustion engine 3. In this way, the vehicle 1 repeats the start-up and stop of the internal combustion engine 3 at comparatively short intervals. A state that the internal combustion engine 3 stops for the change from the hybrid mode to the EV mode is called an intermittent stop.

In a case that the internal combustion engine 3 is restarted from its intermittent stop, the ECU 30 changes the start-up condition including the fuel injection amount, intake airflow rate and the like for the moment of start-up, according to the alcohol density of the fuel. As the alcohol density of fuel is higher, the volatility becomes lower and the start-up performance is deteriorated. Due to this, for example, as the alcohol density is higher, the ECU 30 more increases the fuel injection amount for the moment of start-up. Further, in a case that the alcohol density of fuel exceeds a predetermined criterion, the ECU 30 may execute, at the moment of the start-up, fuel-heating for heating the fuel using an electric fire not illustrated, or may execute a throttle guard for prompting the volatility of the fuel by reducing the opening degree of the throttle valve 14 for increasing an intake negative pressure at the moment of start-up.

In a case that supplied is new fuel which is different in the alcohol density from old fuel remaining in the fuel tank 16 or the fuel pathway 17, the alcohol density of fuel changes before and after the fueling. Until fuel having an alcohol density changed by the fueling (hereinafter “the post-fueling fuel”) is supplied to the internal combustion engine 3, the operation and start-up of the internal combustion engine 3 are executed based on the alcohol density of the old fuel. If the internal combustion engine 3 is in the middle of operating at the moment when the post-fueling fuel is supplied to the internal combustion engine 3, there is not so big damage inflicted on the continuation of operation of the internal combustion engine 3. However, if the internal combustion engine 3 is stopped for the intermittent stop at the moment immediately before the post-fueling fuel is supplied to the internal combustion engine 3, for example, the internal combustion engine 3 is not made to start up on the start-up condition set based on the alcohol density of the post-fueling fuel, and thereby, the start-up performance of the internal combustion engine 3 could be deteriorated. Due to this, in a case that the fueling causing the change of the alcohol density is implemented to the vehicle 1, the ECU 30 prohibits the intermittent stop of the internal combustion engine 3 until the post-fueling fuel is supplied to the internal combustion engine 3.

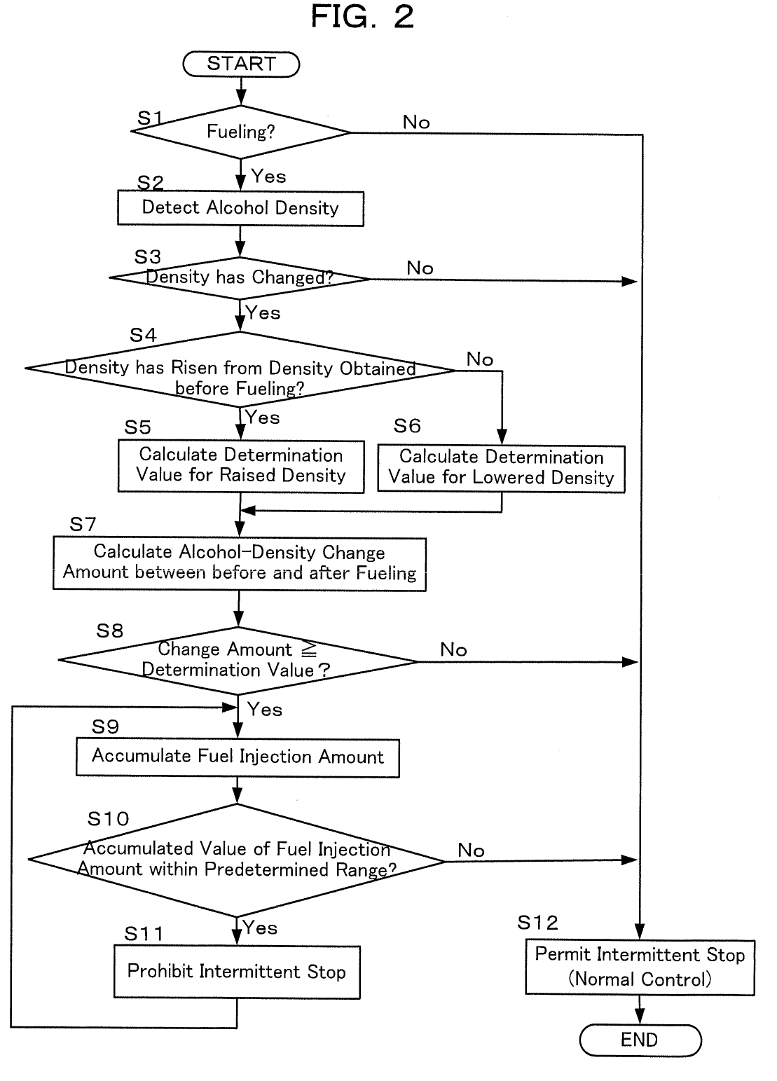

Hereinafter, one example of control to be executed by the ECU 30 will be described with reference to FIG. 2. A computer program for the control routine shown in FIG. 2 is held by the ECU 30, and is read out as appropriate to be executed repeatedly at predetermined intervals.

At step S1, the ECU 30 determines whether or not fueling has been implemented to the vehicle 1. The ECU 30 determines that the fueling has been implemented in a case that the fuel level of the fuel tank 16 has increased by referring to the signal from the fuel level sensor 35. In a case that the ECU 30 determines that the fueling has been implemented, the ECU 30 goes to step S2, and in a case that the ECU 30 does not determine that, the ECU 30 goes to step S12. At step S12, the ECU 30 executes normal control where the intermittent stop of the internal combustion engine 3 is permitted.

At step S2, the ECU 30 refers to the signal from the alcohol density sensor 34 to detect the alcohol density of the fuel. Next, at step S3, the ECU 30 determines whether or not the alcohol density of the fuel has changed. Thereby, it is possible to determine whether the fueling to the vehicle 1 is the one causing a change of alcohol density. As putative embodiments of the fueling causing the change of alcohol density of the fuel, there is an embodiment that alcohol-containing fuel has been supplied in a state that gasoline remains in the fuel tank 16 and/or the fuel pathway 17, and an embodiment that alcohol-containing fuel remains in the fuel tank 16 and/or the fuel pathway 17 and another alcohol-containing fuel having a alcohol density different from the remaining fuel has. If the alcohol density has changed, the ECU 30 goes to step S4, and if the alcohol density has not changed, the ECU 30 goes to step S12.

At step S4, the ECU 30 determines whether or not the alcohol density has risen from the alcohol density obtained before the fueling. In a case that the alcohol density has risen, the ECU 30 goes to step S5, and in a case that the alcohol density has not risen, the ECU 30 goes to step S6. At respective steps S5 and S6, the ECU 30 calculates a determination value of a change amount of the alcohol density for determining necessity that the intermittent stop of the internal combustion engine 3 should be prohibited. It is not necessary to prohibit the intermittent stop, if the change amount of the alcohol density belongs to a degree which does not impinge on the start-up performance of the internal combustion engine 3. Due to this, the determination value is calculated in consideration of the influence on the start-up performance of the internal combustion engine 3. While, even if the alcohol-density change amounts between before and after the fueling are equal to each other, there is a difference in a degree of influence on the start-up performance between the two cases: one case that the alcohol density changes between before and after the fueling so as to rise; and another case that the alcohol density changes between before and after the fueling so as to lower. Accordingly, in a case that the alcohol density has risen the ECU 30 calculates the determination value for raised density at step S5, and in a case that the alcohol density has lowered the ECU 30 calculates the determination value for lowered density at step S6.

There are two elements which impinge on the start-up performance of the internal combustion engine 3: the alcohol density before the fueling; and the alcohol-density change amount between before and after the fueling. In the present embodiment, a map for raised density and a map for lowered density are made and stored in the ECU 30 in advance, based on investigation of a relation between: the start-up performance of the internal combustion engine 3; and the alcohol density of fuel and the change amount of alcohol density, the investigation being obtained by means of prototype tests or simulations. In the respective maps for raised density and for lowered density, the alcohol density before fueling and the change amount (the determination value) of alcohol density at which the intermittent stop should be prohibited are correlated with each other. The ECU 30, at step S5, calculates the determination value correlated to the alcohol density before the fueling by referring to the map for raised density, and at step S6, calculates the determination value correlated with the alcohol density before the fueling by referring to the map for lowered density. In a case that the ambient temperature is low, the start-up performance of the internal combustion engine 3 is more deteriorated. Therefore, the above maps for calculating the determination values may be made as a two-dimensional map where the alcohol density before fueling and the ambient temperature are set as valuables. When using such maps, the ECU 30 refers to the signal from the ambient temperature sensor 33 to detect the ambient temperature and uses the ambient temperature for the calculation of the determination value.

At step S7, the ECU 30 calculates the alcohol-density change amount between before and after the fueling. Next, at step S8, the ECU 30 determines whether or not the change amount of alcohol density calculated at step S7 is the determination value calculated at step S5 or step S6 or more. As mentioned above, the determination value is calculated in consideration of the influence on the start-up performance of the internal combustion engine 3. Due to this, in a case that the change amount of alcohol density is equal to the determination value or more, the ECU 30 goes to step S9 to prohibit the intermittent stop, and in a case that the change amount of alcohol density is less than the determination value, the ECU 30 goes to step S12 to execute the normal control where the intermittent stop is permitted.

At step S9, the ECU 30 accumulates the fuel injection amount with respect to a period after the fueling, and stores the accumulated value of the fuel injection amount. At step S10, the ECU 30 determines whether or not the accumulated value of the fuel injection amount is within a predetermined range. In a case that the accumulated value of the fuel injection amount is within the predetermined range, the ECU 30 prohibits the intermittent stop of the internal combustion engine 3 at step S11 and returns to step S9. Thereby, until the accumulated value of fuel injection amount accumulated after the fueling exceeds the predetermined range, the intermittent stop of the internal combustion engine 3 is prohibited. The predetermined range corresponds to the volume of a part of the fuel pathway 17 from the alcohol density sensor 34 to the internal combustion engine 3. The moment when the post-fueling fuel is supplied to the internal combustion engine 3 is coincident with the moment when such a volume of fuel is injected. Accordingly, when the processing from step S9 to step S11 is executed, thereby, the intermittent stop of the internal combustion engine 3 is prohibited until the post-fueling fuel is supplied to the internal combustion engine 3. In a case that the accumulated value of fuel injection amount exceeds the predetermined value, the ECU 30 goes to step S12 to execute the normal control where the intermittent stop is permitted.

According to the above embodiment, in a case that the fueling causing change of alcohol density of fuel is implemented to the vehicle 1, the intermittent stop is prohibited until the post-fueling fuel is supplied to the internal combustion engine 3. Due to this, it is avoidable that the intermittent stop is implemented at the moment immediately before the post-fueling fuel is supplied to the internal combustion engine 3. Thereby, it is possible to prevent the start-up performance of the internal combustion engine 3 from deteriorating.

Further, since the determination value for determining prohibition of the intermittent stop of the internal combustion engine 3 is determined in consideration of the influence on the start-up performance of the internal combustion engine 3, it is avoidable that the intermittent stop is prohibited even if the alcohol density changes by a degree which impinges in the start-up performance of the internal combustion engine 3. Thereby, it is possible to reduce an adverse effect such as fuel deterioration caused by the prohibition of the intermittent stop. The determination value is set so that the value is different between a case that the alcohol density rises for the period between before and after the fueling and a case the alcohol density lowers for the period between before and after the fueling. Accordingly, the determination value is possible to be set suitably to each of the cases that the alcohol density rises and lowers. Thereby, it is possible to prohibit more appropriately the intermittent stop of the internal combustion engine 3.

According to the present embodiment, the intermittent stop is prohibited until the accumulated value that the fuel injection amount of the internal combustion engine 3 is accumulated after the fueling exceeds the predetermined range corresponding to the volume of the part of the fuel pathway 17 from the alcohol density sensor 34 to the internal combustion engine 3. Due to this, the prohibition period of the intermittent stop is terminated in time with the timing when the post-fueling fuel is supplied to the internal combustion engine 3. Thereby, it is possible to suppress an excessively long prohibition period of the intermittent stop.

The present invention is not limited to the above embodiment, and may be implemented in various embodiments within the subject-matter of the present invention. In the above embodiment, the prohibition period of the intermittent stop is determined based on the accumulated value of the fuel injection amount. However, this is just one example. As the other embodiment where the intermittent stop is prohibited until the post-fueling fuel is supplied to the internal combustion engine 3, the prohibition period of the intermittent stop may be determined based on accumulated operation time of the internal combustion engine 3 which is accumulated after the fueling of fuel, for example. Then, the accumulated operation time may be determined in such a way that, for example, a criterion of the accumulated operation time is determined by experimentally investigating an average or the like of the accumulated operation time accumulated until the post-fueling fuel is supplied to the internal combustion engine 3.

This application claims the benefit of foreign priority to Japanese Patent Application No. JP2016-183136, filed Sep. 20, 2016, which is incorporated by reference in its entirety.

1. A control device being applied to a hybrid vehicle in which an internal combustion engine and an electric motor are provided as power sources for propulsion, the internal combustion engine being enabled to operate with fuels different in alcohol density from each other, and start-up condition of the internal combustion engine changes according to alcohol density of fuel, wherein the control device is configured as a computer unit and is programmed to make the internal combustion engine stop for an intermittent stop to make the electric motor propel the hybrid vehicle, wherein
the control device is further programmed to, in a case that fueling which causes change of alcohol density of fuel is implemented to the hybrid vehicle, prohibit the intermittent stop of the internal combustion engine until fuel having an alcohol density changed by the fueling is supplied to the internal combustion engine.

2. The control device according to claim 1, being further programmed to prohibit the intermittent stop of the internal combustion engine in a case that an alcohol-density change amount between before and after the fueling exceeds a determination value.

3. The control device according to claim 2, wherein the determination value is set to a value differently depending on whether a case that the alcohol density rises for a period between before and after the fueling or a case that the alcohol density lowers for the period.

4. The control device according to claim 2, wherein the determination value is set according to the alcohol density obtained before the fueling.

5. The control device according to claim 1, wherein
the hybrid vehicle being provided with: a fuel tank; a fuel pathway running from the fuel tank to the internal combustion engine, and an alcohol density sensor provided on the fuel pathway and outputting a signal according to the alcohol density, and
the control device is further programmed to prohibit the intermittent stop of the internal combustion engine until an accumulated value exceeds a predetermined range corresponding to a volume of a part of the pathway from the alcohol density sensor to the internal combustion engine, the accumulated value being obtained by accumulating a fuel injection amount of the internal combustion engine after the fueling.
